(19) United States
(12) Patent Application Publication
(10) Pub. No.: US 2005/0056676 A1
(43) Pub. Date: Mar. 17, 2005

(54) Adhesive tape cutter

(75) Inventor: Masayuki Nakayama, Chiba (JP)

Correspondence Address: GREENBLUM & BERNSTEIN, P.L.C., 1950 ROLAND CLARKE PLACE, RESTON, VA, 20191, US

(73) Assignee: KTF CORPORATION, Tokyo (JP)

(21) Appl. No.: 10/929,371

(22) Filed: Aug. 31, 2004

(30) Foreign Application Priority Data
Sep. 1, 2003 (JP) 2003-308407

(51) Int. Cl. B26F 3/02; B32B 31/00

(52) U.S. Cl. 225/47; 156/517; 156/523; 225/39; 83/478

(57) ABSTRACT

An adhesive tape cutter is provided with a circular cutting blade, and by making the cutting portion that comes into contact with the tape a roughly 90° partial arc, cutting is possible in the center and also even if the tape is twisted to either the left or right, a cut can be easily made and the tape can be easily cut. The adhesive tape cutter consists of a tape holding mechanism, cutting mechanism, and a support member. The cutting mechanism consists of a circular cutting blade disposed perpendicular to the lengthwise direction of adhesive tape unwound from the roll, and a left and right pair of rotating protective members above the circular cutting blade that also serve as tape guides and that rotate in a direction perpendicular to the lengthwise direction of the tape. The protective members have a structure wherein the bottom surfaces of two hemispheres of different diameters face each other and the flange portion of the bottom edges are linked while separated by a fixed gap, and are also disposed above said circular cutting blade at a distance such that the fingertip does not reach the cutting blade when adhesive tape is pushed down by hand and cut.

### BACKGROUND OF THE INVENTION

1. Field of the Invention

The present invention relates to an adhesive tape cutter used for unrolling adhesive tape that is wound into a roll and cutting it to the desired length, and particularly to an improved adhesive tape cutter that uses circular cutting blades as the cutting blades and can thus withstand long-term usage.

2. Description of Related Art

An adhesive tape cutter typically comprises a tape cutter body that rotatably holds adhesive tape rolled into a roll shape and a saw tooth-shaped cutting blade for cutting the adhesive tape, in a configuration whereby adhesive tape unrolled from the roll is cut to the desired length with the cutting blade. Conventional adhesive tape cutters use saw tooth-shaped cutting blades that are serrated and so do not cut well, and also the cut edge of the tape is also serrated in shape, and thus they have drawbacks in that when tape is applied to the desired area, the clean appearance of a product or item to be adhered to may be lost. Accordingly, it is preferable that the shape of the cutting end area of the cutting blade be a linear blade such as a razorblade, so that the cut end does not become serrated. However, even though it may cut well and the cut end is clean and linear, such a cutting blade is extremely dangerous to use from a handling standpoint so there is a risk of cuts and injuries occurring even when lightly touched, and thus problems remain to be solved from the standpoint of safety.

Thus, a company affiliated with the applicant has proposed an “adhesive tape cutter” (Japanese Registered Utility Model No. 3009748) intended to solve this problem. This invention is provided with a linear blade like that of a razor, giving a linear and sharp cut edge, with a pair of protective members disposed above the blade in order to prevent the fingers from being cut, giving a configuration that guards the blade tip. With this invention, it is possible to equip the cutter with a linear cutting blade so the adhesive tape is cut in a linear fashion, thereby improving its appearance. However, it was still inadequate from the standpoint of sharpness, so by adopting a guillotine-type blade structure wherein the cutting blade is inclined at a slight angle, it is possible to provide an adhesive tape cutter with even better sharpness. However, the adhesive tape cutter described above still has the following drawbacks.

When adhesive tape is cut with a linear cutting blade, not a saw-tooth blade, when the tape is lowered perpendicularly to the cutting blade, the tape will make generally equal contact with the entire cutting blade, so the initial cut will not be made and the tape will be difficult to cut with the force distributed evenly. In order to make the tape easier to cut, a person would naturally set the tape on an angle, so there is a tendency for the adhesive tape to be given a twist when put in contact with the cutting blade. The structure with a guillotine blade arrangement where the blade is inclined at an angle makes the tape easier to cut, but while the adhesive tape can be easily cut if brought down straight, some people may twist the tape to be parallel to the guillotine blade when cutting, conversely making it more difficult to cut. In addition, as the number of cuts increases, the blade becomes dull, so it is necessary to replace not only the blade but the entire cutting blade mechanism in order to return to the original sharpness. Considering the cost of replacement with a new cutting blade, its economy is poor.

Thus, the present inventors made improvements with regard to this point and achieved the development of an adhesive tape cutter that can easily cut tape when force is applied uniformly from above, or even when a twist to the left or right is applied.

Reference Patent Document 1: Registered Utility Model No. 3009748

### SUMMARY OF THE INVENTION

The present invention is an adhesive tape cutter intended to solve the problems described above, and its object is to provide an adhesive tape cutter wherein: the cutting blade is circular in shape and contact location for cutting is a partial arc of roughly 90°, so when the tape is lowered from above, cutting is possible from the center and even if a twist to the left or right is applied to the tape, it is easy to make a cut and sever the tape. In addition, another object is to provide an adhesive tape cutter with a constitution wherein the circular cutting blade can be rotated, so if it is used by rotating one circular blade to expose a new portion, the original sharpness can be constantly maintained, and thus it can withstand long-term use.

In order to achieve the above object, the adhesive tape cutter according to the present invention comprises: an adhesive tape cutter consisting of a tape cutter proper along with a tape holding mechanism that rotatably holds adhesive tape wound as a roll, a cutting mechanism for cutting adhesive tape unwound from the roll at a desired position, and a support member that holds said cutting mechanism, wherein:
the cutting mechanism comprises a circular cutting blade consisting of a circular plate, the outer periphery of which is formed into a cutting blade that cuts adhesive tape disposed perpendicular to the lengthwise direction of adhesive tape unwound from the roll, and a left and right pair of rotating protective members above said circular cutting blade that also serve as tape guides and that rotate in a direction perpendicular to the lengthwise direction of the tape, and said protective members have a structure wherein the bottom surfaces of two hemispheres of different diameters face each other and the flange portion of the bottom edges are linked while separated by a fixed gap, and are also disposed above said circular cutting blade at a distance such that the fingertip does not reach the cutting blade when adhesive tape is pushed down by hand and cut.

In addition, said circular cutting blade is constituted such that a roughly 90° partial arc portion of the 360° blade tip provided on the periphery of the circular plate protrudes from the central upper surface of said support member. Said support member is installed such that a rotation knob on its rear surface for rotating said circular cutting blade engages the center of said circular cutting blade. Moreover, said circular cutting blade has markings applied in appropriate places on the circular blade so that the location being used may be rotated and the cutting portion of the blade tip can be changed and moved as its cutting functionality decreases over long-term use. In addition, said support member is provided on its rear surface with a marking indicator window through which the markings provided on the circular cutting blade can be easily viewed.

The adhesive tape cutter according to the present invention is constituted as described above and thus has the following meritorious effects:

1. The cutting blade of the cutting mechanism is a circular cutting blade, so regardless of whether force is applied from above or twisted to the left or right, however force may be applied to the adhesive tape, a linear and clean cut surface and cut end can be easily formed.

2. The configuration is such that a roughly 20° partial arc portion of the circular cutting blade protrudes from the center of the upper surface of the support member, so adhesive tape of any width can be easily cut.

3. In addition, the circular cutting blade can rotate, so even if one portion is no longer sharp, the circular cutting blade can be rotated so that a sharp portion can be used, and thus it is durable over long-term use and economical.

4. Moreover, a rotation knob is provided so that the circular cutting blade can be easily rotated to change the position of the cutting blade, giving a structure suited to long-term use.

5. The used and unused portions of the blade can be easily distinguished by providing markings on the surface of the circular cutting blade.

6. By providing an indicator window on the support member, the structure allows one to determine at a glance which portion of the rotating cutting blade is being used.

### BRIEF DESCRIPTION OF THE DRAWINGS

FIG. 1 is a perspective view of an adhesive tape cutter according to the present invention.

FIG. 2 is a side view of the adhesive tape cutter.

FIG. 3 is a front view of the adhesive tape cutter.

FIG. 4 is a front view of the cutting mechanism.

FIG. 5 is a cross section of the cutting mechanism along A-A.

FIG. 6 is an exploded perspective view of the cutter.

### DESCRIPTION OF THE PREFERRED EMBODIMENTS

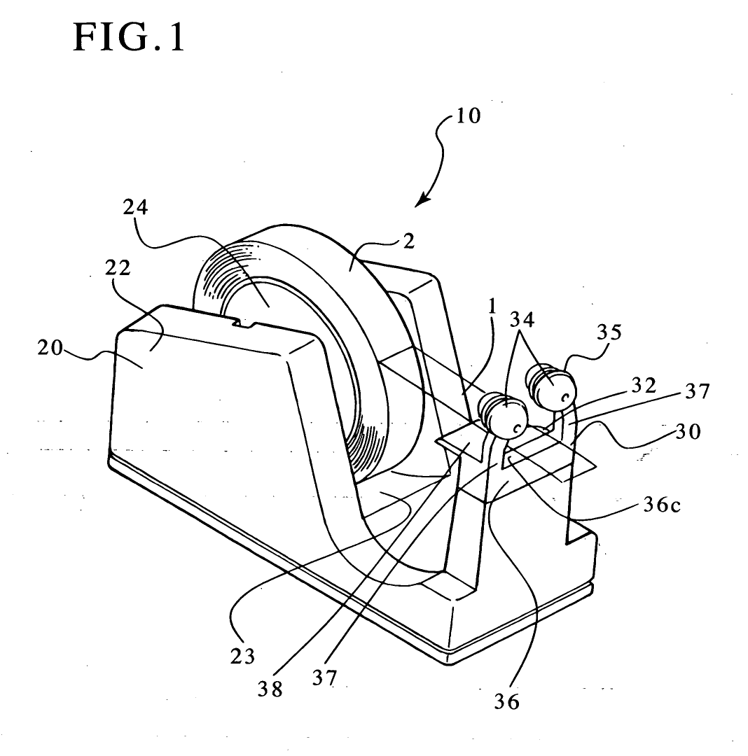

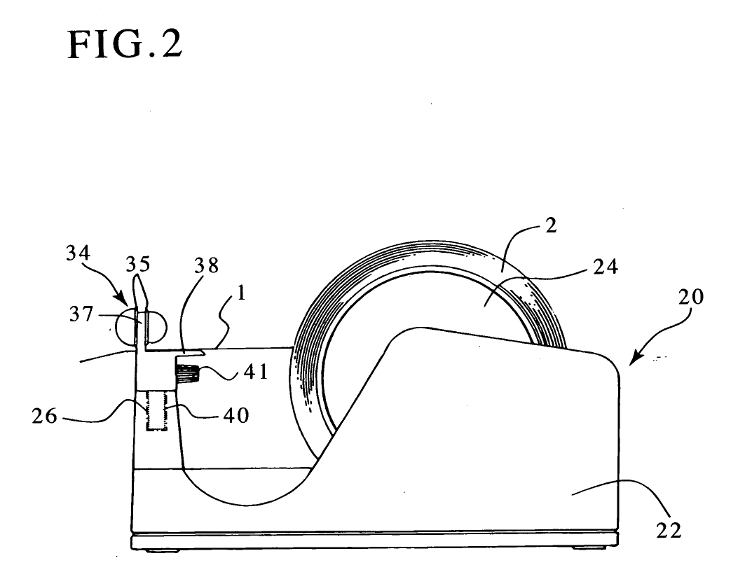

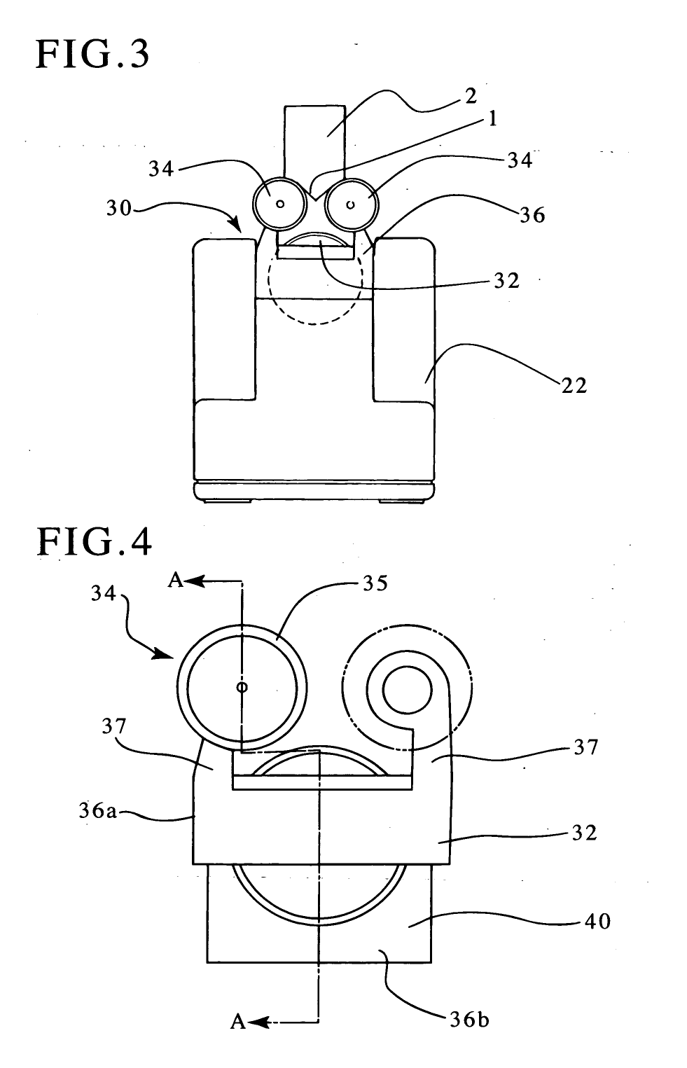

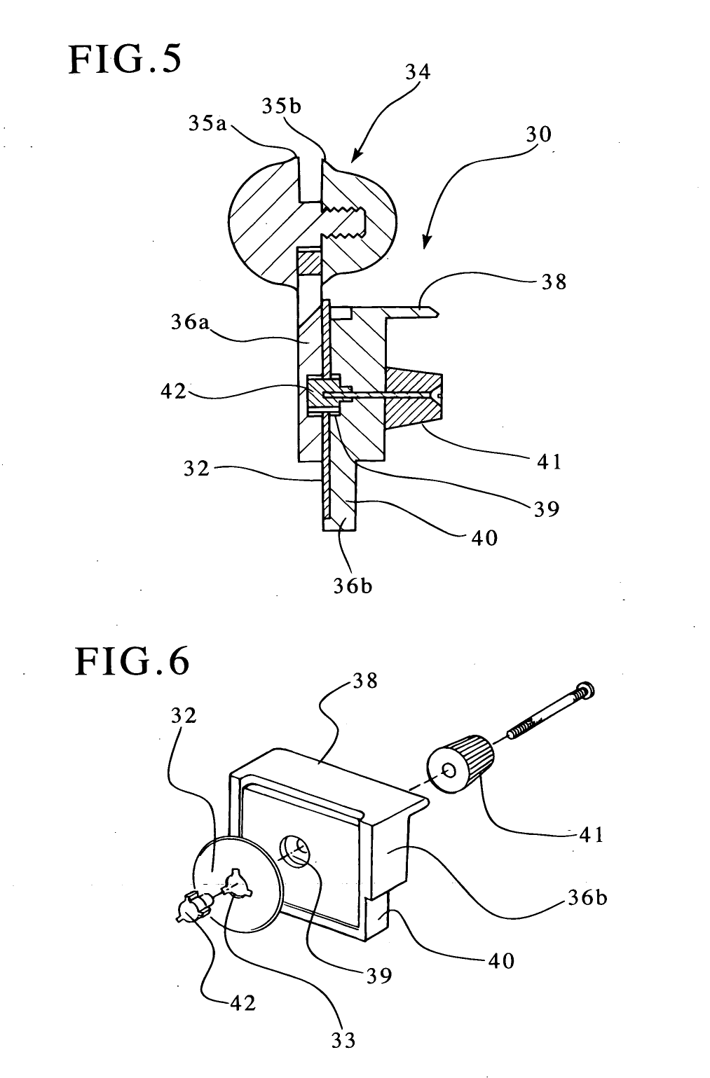

The adhesive tape cutter according to the present invention will now be explained in detail based on an embodiment illustrated in the drawings. FIG. 1 is a perspective view of an adhesive tape cutter according to the present invention. FIG. 2 is a side view of the adhesive tape cutter. FIG. 3 is a front view of the adhesive tape cutter. FIG. 4 is a front view of the cutting mechanism. FIG. 5 is a cross section of the cutting mechanism along A-A. FIG. 6 is an exploded perspective view of the cutter.

The adhesive tape cutter 10 according to the present invention consists of a holding mechanism 20, cutting mechanism 30 and cutting mechanism support member 36.

The holding mechanism 20 consists of a tape cutter proper 22, reel 24 and mounting hole 26. The tape cutter proper 22 is the cutter body that combines the functions of containing and cutting adhesive tape in the shape of a long, thin rectangular parallelepiped, with an indentation 23 for containing tape formed lengthwise in the center. A reel 24 for mounting a roll 2 around which is wound a plurality of layers of adhesive tape 1 is rotatably and removably installed within this indentation 23. The indentation 23 and reel 24 constitute the holding mechanism 20.

In addition, a cutting mechanism 30 for cutting the adhesive tape 1 unwound from the roll 2 is provided at the front end of the tape cutter proper 22 with the support member 36 interposed between.

The reel 24 is a circular fitting form used for mounting a roll 2 around which is wound a plurality of layers of adhesive tape 1, and in order to handle rolls of different inside diameters, its structure is such that the central portion can be divided into a small-diameter shaft portion and a large-diameter circular portion. The size of the reel is not limited thereto, but rather it is also possible to use reels that can also handle rolls of different inside diameters.

The mounting hole 26 is a hole for removably fitting the cutting mechanism 30 onto the tape cutter proper 22.

The cutting mechanism 30 consists of a circular cutting blade 32, protective members 34 and a rotation knob 41. The cutting mechanism is the portion where tape 1 unwound from the roll 2 is cut at appropriate places. The circular cutting blade 32 consists of a circular plate where the entire outer periphery is made into a cutting blade, being disposed between the left and right support arms 37 of the support member 36. The circular cutting blade has a roughly 90° partial arc portion of the 360° blade tip provided on the periphery of the circular plate protruding from the central upper surface 36c of the support member 36. In addition, a triangular, square or other-shaped center hole 33 is cut along the central axis of the circular cutting blade 32 in order to engage and rotate with the rotation knob 41. Note that in this embodiment, as shown in FIG. 6, a center hole 33 with the shape of a circle to which protrusions are provided in three places is cut. Moreover, in this embodiment, markings are applied to the surface of the circular cutting blade 32 at roughly 45° intervals, being marked with the numbers from 1 to 8. This is so that, when the circular blade in the portion where the adhesive tape is cut becomes dull, the rotation knob 41 can be used to rotate the circular cutting blade 32 so that the blade can be used in the area of a different marking, so a sharp portion can be used. This solves a drawback of the conventional horizontal-type or guillotine-type cutting blade by eliminating the cost of purchasing a new cutting blade mechanism once the blade becomes dull. The angles at which the markings are applied and the shape of the center hole 33 may be set arbitrarily.

The protective members 34 consist of two spherical rotating members that protect the fingers from the cutting blade, having a constitution wherein spheres that rotate in a direction perpendicular to the direction in which the adhesive tape 1 is unwound are attached to the upper ends of the left and right support arms 37 which extend upward from the support member 36. Between this pair of protective members is maintained a gap of a size that is able to protect the fingertip from coming into contact with the circular cutting blade 32 while still allowing the adhesive tape 1 to be pushed down toward the circular cutting blade 32. In addition, on the pair of protective members 34 are formed two flanges 35a and 35b having their pointed edges kept on the outside, with a slight gap in front and back.

When the adhesive tape 1 is pressed down and pushed against the circular cutting blade 32, the flanges 35a and 35b support and guide the adhesive tape 1 so that it does not come into contact with portions other than the flanges 35a and 35b of the protective members 34, but the outer peripheries of the flanges 35a and 35b are pointed edges, so even if the adhesive surface of the adhesive tape 1 should come into contact with the edge, the adhesion force is extremely small and limited, so the constitution is such that there is no unnecessary adhesion. It is possible to provide a plurality of flanges on the protective members 34 and as a result, the support of the adhesive tape 1 by these flanges 35a and 35b can be performed more reliably and stably.

The support member 36 consists of a separably joined front portion 36a and rear portion 36b, left and right support arms 37, a holding table 38 and a fitting area 40. As shown in FIG. 5, the circular cutting blade 32 is held between the front portion 36a and rear portion 36b of the support member such that it is replaceable.

Upon the front portion 36a are formed the support arms 37 where the pair of protective members 34 are attached. Note that in this embodiment, it is also conceivable to form an indicator window so that one can see at a glance which portion of the circular cutting blade 32 is in use.

In addition, upon the rear portion 36b is formed the holding table 38 for adhesively holding the remainder of the adhesive tape after it is cut, and moreover the rotation knob 41 is disposed on the back and an engaging hole 39 is provided so as to engage the circular cutting blade 32. The fitting area 40 is provided at the bottom edge of the rear portion 36b, being formed in a shape such that it fits into the mounting hole 26 of the tape cutter proper 22, and thus it can be easily mounted into the mounting hole 26. In addition, the configuration may also be such that a stopper or the like is formed so that it is solid and is not easily removed while in use.

As shown in FIG. 5 and the exploded perspective view of FIG. 6, the rotation knob 41 is joined by a screw or the like to a protrusion 42 that fits into the center hole 33 of the circular cutting blade 32, so the circular cutting blade 32 can be rotated by rotating the rotation knob 41. This rotation knob 41 can be made to rotate freely, but it is also possible to induce a small amount of resistance to rotation, thus achieving a constitution where the knob is positioned at each marking as in a dial-type switch.

The cutting mechanism of the adhesive tape cutter according to the present invention is equipped with a circular cutting blade rather than the ordinary horizontal or guillotine-type cutting blade, and thus regardless of whether the adhesive tape is brought down vertically upon the circular cutting blade or brought down with a twist to the left or right added, and regardless of how the cutting is done or how the force is applied, not only do all cutting surfaces and cut edges become linear but also it is possible to obtain a cutting surface with a good appearance can be obtained. In addition, by adopting a circular cutting blade, when the blade becomes dull, the rotation knob can be rotated to use a different portion of the blade on the outside of the circular cutting blade that has not yet been used, so it can be used much longer than the lifetime of an ordinary cutting blade. In addition, protective members are provided so that it can be used safely without the concern of causing injuries to fingers or the like.

1. An adhesive tape cutter consisting of a tape cutter proper along with a tape holding mechanism that rotatably holds adhesive tape wound as a roll, a cutting mechanism for cutting adhesive tape unwound from the roll at a desired position, and a support member that holds said cutting mechanism, wherein:
the cutting mechanism comprises a circular cutting blade consisting of a circular plate, the outer periphery of which is formed into a cutting blade that cuts adhesive tape disposed perpendicular to the lengthwise direction of adhesive tape unwound from the roll, and a left and right pair of rotating protective members above said circular cutting blade that also serve as tape guides and that rotate in a direction perpendicular to the lengthwise direction of the tape, and
said protective members have a structure wherein the bottom surfaces of two hemispheres of different diameters face each other and the flange portion of the bottom edges are linked while separated by a fixed gap, and are also disposed above said circular cutting blade at a distance such that the fingertip does not reach the cutting blade when adhesive tape is pushed down by hand and cut.

2. An adhesive tape cutter according to claim 1, wherein a roughly 90° partial arc portion of the 360° blade tip provided on the periphery of the circular plate protrudes from the central upper surface of said support member.

3. An adhesive tape cutter according to claim 1, wherein said circular cutting blade is rotatably installed such that the roughly 90° portion used for cutting can be moved and changed.

4. An adhesive tape cutter according to claim 1, wherein said support member is installed such that a rotation knob on its rear surface for rotating said circular cutting blade engages the center of said circular cutting blade.

5. An adhesive tape cutter according to claim 1, wherein said circular cutting blade has markings applied in appropriate places on the circular blade so that the location being used may be rotated and the cutting portion of the blade tip can be changed and moved as its cutting functionality decreases over long-term use.

6. An adhesive tape cutter according to claim 1, wherein said support member is provided on its rear surface with a marking indicator window through which the markings provided on the circular cutting blade can be easily viewed.
